(19) United States
(12) Patent Application Publication
(10) Pub. No.: US 2010/0079571 A1
(43) Pub. Date: Apr. 1, 2010

(54) DRAWING APPARATUS AND METHOD, AND COMPUTER PROGRAM

(76) Inventor: Tetsuya HAYASHI, Koutoh (JP)

Correspondence Address: YOUNG & THOMPSON, 209 Madison Street, Suite 500, Alexandria, VA, 22314, US

(21) Appl. No.: 12/519,611

(22) PCT Filed: Dec. 21, 2006
(86) PCT No.: PCT/JP2006/325482

§ 371 Date: Sep. 1, 2009

(51) Int. Cl. B41J 2/47

(52) U.S. Cl. 347/225

(57) ABSTRACT

A drawing device includes a drawing element irradiating laser light to a label surface of a recording medium according to drawing data of tracks to compose a desired pattern and draw it on the label surface. The drawing device further includes a juncture specifying element that specifies a juncture portion between drawing start and end positions according to the drawing data and a non-drawing portion specifying element that specifies a non-drawing portion corresponding to the drawing data not to direct the irradiation of the laser light in accordance with the drawing data. The drawing device includes a control element controlling the drawing element to carry out movement processing so the drawing start position in each of a plurality of the tracks moves relative to the desired pattern to be drawn in order for at least a part of the specified juncture portion to be received in the specified non-drawing portion.

### TECHNICAL FIELD

The present invention relates to a drawing apparatus for and method of drawing a pattern such as a character or a letter, a graphic, and an image, for example, onto a label surface of a recording medium, and a computer program.

### BACKGROUND ART

An optical disc such as a CD and a DVD allows large volumes of data to be recorded thereon easily. As the data recorded on the optical disc, for example, software, computer applications, computer files, video data, music data, and the like are listed as one specific example. Such an optical disc stores the data digitally. More specifically, a high-intensity laser beam is used to burn a small area of the optical disc (i.e. to change optical properties in the small area), so that a pit pattern according to the data to be recorded makes each small area reflective or unreflective. By this, it is possible to record the data onto the optical disc.

In recent years, in such an optical disc, a user's desired pattern (e.g. a desired image, character or letter, graphic, and the like) has been frequently drawn on a label surface, which is a surface on the opposite side of a recording surface on which the data is recorded. Typically, a simple action of using a pen or the like to draw the desired pattern and an action of using an ink jet printer to draw the desired pattern can be listed as one specific example.

On the other hand, as a technology of drawing the desired character or letter, graphic, and image, there has been developed a technology of laminating a pigmented film or the like on the label surface and applying a laser beam to the label surface (i.e. the pigmented film), thereby drawing the desired pattern onto the label surface (refer to patent documents 1 and 2). According to this technology, since the desired pattern can be drawn on the label surface using a hardware configuration for recording the data (specifically, an optical pickup or the like), it is possible to draw the clear image, character or letter, graphic, and the like on the label surface, relatively easily.

Patent document 1: US Patent Publication No. 6771297
Patent document 2: Japanese Patent Application Laid Open No. 2006-511034

### DISCLOSURE OF INVENTION

### Subject to be Solved by the Invention

By the way, in the technology of drawing the desired pattern on the label surface, as described above, if the drawing is performed in each circle (or track) with drawing and displacing radial position being repeatedly, there is a joint between a recording start portion and a recording end portion of the one cycle. In performing the drawing near the joint, a slight gap (i.e. a lack of the drawing) and overlap (i.e. an excess of the drawing) occur due to an error that cannot be controlled by the rotation control or the like of a spindle which rotates an optical disc or the like, or due to a calculation error. Thus, drawing quality in the joint portion looks inferior to another portion. In particular, this tendency is much stronger, for example, if the joint portion is formed linearly and continuously. In order to solve the problems, if the drawing is excessively performed in the joint portion to thereby intentionally form the overlap, occurring gap is avoided; however, there is a contrast difference, so the drawing quality is still reduced.

In view of the aforementioned problems, it is therefore an object of the present invention to provide a drawing apparatus and method which can improve the drawing quality in drawing the desired pattern onto the label surface, and a computer program for operating a computer as such a drawing apparatus.

### Means for Solving the Subject

The above object of the present invention can be achieved by a drawing apparatus provided with: a drawing device for drawing a desired pattern onto a label surface by applying a laser beam to the label surface provided for a recording medium in accordance with drawing data on a plurality of tracks which constitute the desired pattern; a joint specifying device for specifying a joint portion between a drawing start position at which the drawing device starts the drawing and a drawing end position at which the drawing device ends the drawing, in each of the plurality of tracks, on the basis of the drawing data; a not-drawn portion specifying device for specifying a not-drawn portion corresponding to the drawing data indicating that the laser beam is not applied, on the label surface, on the basis of the drawing data; and a controlling device for controlling the drawing device to perform a displacement process of displacing the drawing start position in each of the plurality of tracks relatively to the drawn desired pattern such that the specified joint portion is included at least partially in the specified not-drawn portion.

The above object of the present invention can be also achieved by a drawing method in a drawing apparatus provided with: a drawing device for drawing a desired pattern onto a label surface by applying a laser beam to the label surface provided for a recording medium in accordance with drawing data on a plurality of tracks which constitute the desired pattern, the drawing method provided with: a joint specifying process of specifying a joint portion between a drawing start position at which the drawing device starts the drawing and a drawing end position at which the drawing device ends the drawing, in each of the plurality of tracks, on the basis of the drawing data; a not-drawn portion specifying process of specifying a not-drawn portion corresponding to the drawing data indicating that the laser beam is not applied, on the label surface, on the basis of the drawing data; and a controlling process of controlling the drawing device to perform a displacement process of displacing the drawing start position in each of the plurality of tracks relatively to the drawn desired pattern such that the specified joint portion is included at least partially in the specified not-drawn portion.

The above object of the present invention can be also achieved by a computer program for controlling a computer provided in a drawing apparatus provided with: a drawing device for drawing a desired pattern onto a label surface by applying a laser beam to the label surface provided for a recording medium in accordance with drawing data on a plurality of tracks which constitute the desired pattern; a joint specifying device for specifying a joint portion between a drawing start position at which the drawing device starts the drawing and a drawing end position at which the drawing device ends the drawing, in each of the plurality of tracks, on the basis of the drawing data; a not-drawn portion specifying device for specifying a not-drawn portion corresponding to the drawing data indicating that the laser beam is not applied, on the label surface, on the basis of the drawing data; and a controlling device for controlling the drawing device to perform a displacement process of displacing the drawing start position in each of the plurality of tracks relatively to the drawn desired pattern such that the specified joint portion is included at least partially in the specified not-drawn portion, the computer program making the computer function as at least the controlling device.

These operation and other advantages of the present invention will become more apparent from the embodiments explained below.

### BRIEF DESCRIPTION OF DRAWINGS

FIG. 1 is a block diagram conceptually showing the basic structure of a recording/reproducing apparatus in a first example.

FIG. 2 is a plan view showing the basic structure of an optical disc (in particular, a characteristic data recording area 121) which is a target for the operations of the recording/reproducing apparatus in the first example.

FIG. 3 is a plan view showing the basic structure of the optical disc (in particular, an enlarged view of a label drawn in a label area 122) which is a target for the operations of the recording/reproducing apparatus in the first example.

FIG. 4 is a flowchart conceptually showing a flow of a drawing process in the first example.

FIG. 5 is a flowchart conceptually showing a flow of a track drawing process.

FIG. 6 is an enlarged view of the label area 122 schematically showing a result of a displacement process.

FIG. 7 is an enlarged view of the label area 122 schematically showing a result of the displacement process.

FIG. 8 is an enlarged view of the label area 122 schematically showing a result of a dispersion process.

### DESCRIPTION OF REFERENCE CODES

1 information recording/reproducing apparatus
11 spindle motor
12 optical pickup unit
13 optical pickup
14 thread
15 stepping motor
51 encoder
52 encoder controller
16 OPU controller
17 stepping controller
18 spindle controller
21 data bus
31 system controller
32 memory
41 display device
42 input device
100 optical disc
110 data recording layer
120 label layer
121 characteristic data recording area
122 label area
1211, 1212, 1213 pattern
141, 142, 143 track

### BEST MODE FOR CARRYING OUT THE INVENTION

Hereinafter, as the best mode for carrying out the present invention, an explanation will be given on embodiments of the drawing apparatus and method, and the computer program of the present invention.

### Embodiment of Drawing Apparatus

An embodiment of the drawing apparatus of the present invention is a drawing apparatus provided with: a drawing device for drawing a desired pattern onto a label surface by applying a laser beam to the label surface provided for a recording medium in accordance with drawing data on a plurality of tracks which constitute the desired pattern; a joint specifying device for specifying a joint portion between a drawing start position at which the drawing device starts the drawing and a drawing end position at which the drawing device ends the drawing, in each of the plurality of tracks, on the basis of the drawing data; a not-drawn portion specifying device for specifying a not-drawn portion corresponding to the drawing data indicating that the laser beam is not applied, on the label surface, on the basis of the drawing data; and a controlling device for controlling the drawing device to perform a displacement process of displacing the drawing start position in each of the plurality of tracks relatively to the drawn desired pattern such that the specified joint portion is included at least partially in the specified not-drawn portion.

According to the embodiment of the drawing apparatus in the present invention, as detailed later, it is possible to improve drawing quality in drawing the desired pattern onto the label surface.

In drawing the desired pattern onto the label surface (which indicates a surface on the side that is a drawing target of the both surfaces of an optical disc and which typically indicates a surface on the opposite side of a recording surface, but which may also indicate a surface on the same side), the laser beam is applied to the label surface provided for the recording medium, by the drawing device (e.g. an optical pickup having a semiconductor laser device, a lens, and the like), in accordance with the drawing data (e.g. image data such as bitmap and vector data) on the plurality of tracks which constitute the desired pattern. Specifically, the drawing device can be displaced, for example, in a radial direction of the recording medium (in other words, a tracking direction) along the label surface. Moreover, for example, a pigmented film or the like is applied on the label surface, and the desired pattern is drawn on the label surface by using a difference between the reflectance of the pigmented film in a portion that is irradiated with the laser beam and the reflectance of the pigmented film in a portion that is not irradiated with the laser beam. At this time, the track is searched for, for example, by a thread driven by a stepping motor and an actuator provided for an optical pickup.

Here, the joint portion between the drawing start position at which the drawing starts the drawing and the drawing end position at which the drawing device ends the drawing is specified by the joint specifying device (e.g. a system controller and a memory) in each of the plurality of tracks, on the basis of the drawing data. The “drawing start position” herein indicates a position at which the drawing device starts the drawing, and the “drawing end position” herein indicates a position at which the drawing device ends the drawing. The positions are expressed, for example, by an angle between the drawing start position and a certain reference position, centered on a center hole of the optical disc. The “joint portion” is a portion in which a slight gap and overlap can occur due to an error that cannot be controlled by the rotation control or the like of a spindle controller which rotates the optical disc or due to a calculation error. “Specifying the joint portion” in effect specifies aspect of the generated joint portion on the label surface, such as a position, placement, shape, and the like on the label surface of the joint portion. These can be specified on the basis of the drawing data, for example, on the basis of arrangement of bits included in one cycle of each track, a bit length corresponding to one cycle, and a deviation of the drawing start position generated by a search between the tracks.

By the way, if there is this type of gap and overlap, as described in Subject to be Solved by the Invention, the drawing quality in the joint portion looks inferior to another portion.

Thus, on the label surface, the not-drawn portion corresponding to the drawing data (e.g. “0”) indicating that the laser beam is not applied on the label surface is specified by the not-drawn portion specifying device “(e.g. a system controller and a memory) on the basis of the drawing data. The “not-drawn portion” herein is, in other words, a portion which is not irradiated with the laser beam and in which nothing is drawn. It is preferable in terms of a wait time because the not-drawn portion has a closer distance from the original joint portion, and it is preferable in terms of a capacity because the not-drawn portion has a wider width. The not-drawn portion may include not only a portion that is not irradiated with the laser beam at all, but also a portion that is hardly irradiated with the laser beam (e.g. a portion 99% of which corresponds to “0”). Moreover, the not-drawn portion may not be connected in an integrated manner on the label surface, and it may be formed of a plurality of separated areas. “Specifying the not-drawn portion” in effects specifies aspect of the generated not-drawn portion on the label surface, such as a position, placement, shape, and the like on the label surface of the not-drawn portion. These can be specified on the basis of the drawing data, for example, on the basis of a not-drawn area included in the desired pattern and the drawing data corresponding to this area. “Specifying the “not-drawn portion” also includes specification of an indication of a case where there is no not-drawn portion (i.e. a case where some pattern is drawn on the entire label surface).

Then, the drawing device is controlled by the controlling device (e.g. a system controller or an OPU controller or the like) to perform the displacement process detailed later; namely, the drawing start position in each of the plurality of tracks is displaced relatively to the drawn desired pattern such that the joint portion specified in the above manner is included at least partially in the not-drawn portion specified in the above manner. In other words, the displacement process is performed such that the joint portion is included (in other words, spatially included) at least partially (preferably entirely) in the not-drawn portion. At this time, the extent of the displacement can be calculated from a position relation or the like between the joint portion specified in advance and the not-drawn portion. As a result, of the joint portion, the portion included in the not-drawn portion is hidden in the not-drawn portion even if it is originally a gap. In other words, an observer cannot distinguish between the gap and the not-drawn portion if nothing is drawn in the joint portion. This means that the drawing quality is not reduced by the joint portion.

As is seen above, according to the drawing apparatus of the present invention, it is possible to preferably improve the drawing quality in drawing the desired pattern on the label surface, so that it is extremely useful in practice.

In one aspect of the embodiment of the drawing apparatus of the present invention, it is further provided with a first judging device (e.g. a system controller and a memory) for judging whether or not extent of a deviation (e.g. a deviation caused by a search) of the drawing start position between adjacent tracks of the plurality of tracks is below a predetermined deviation threshold value (a threshold value predetermined by experiments, experiences, and simulations, as an upper limit value of the extent of the deviation in which the adjacent tracks look like being connected, to an observer) but beyond a predetermined ratio threshold value (a threshold value predetermined by experiments, experiences, and simulations, as a lower limit value of a ratio of the track that satisfies the conditions for the deviation, with respect to all the tracks), the controlling device controlling the drawing device to perform the displacement process if it is judged that the extent is beyond the predetermined ratio threshold value (i.e. the deviation of the drawing start position between the tracks is so small on the whole that the joint portion possibly looks like being continuously connected, like a straight line or a curve).

According to this aspect, if it is judged that the extent is beyond the predetermined ratio threshold value, i.e. if the deviation of the drawing start position between the tracks is so small on the whole that the joint portion possibly looks like being continuously connected, like a straight line or a curve, the displacement process is selectively performed. In other words, it is possible to selectively avoid a reduction in the drawing quality if the joint portion is particularly noticeable, so that it is extremely useful in practice.

In another aspect of the embodiment of the drawing apparatus of the present invention, it is further provided with a second judging device (e.g. a system controller and a memory) for judging whether or not the joint portion specified on the label surface is included in the specified not-drawn portion beyond a predetermined amount threshold value (a threshold value predetermined by experiments, experiences, and simulations, as a lower limit value of a spatial ratio occupied by the portion included in the not-drawn portion of the joint portion, in which it is recognized that performing the displacement process results in more improvement in the drawing quality than performing the dispersion process), the controlling device controlling the drawing device to perform the displacement process if it is judged that the specified joint portion is included in the specified not-drawn portion beyond the predetermined amount threshold value, the controlling device controlling the drawing device to perform, instead of the displacement process, a dispersion process of displacing the drawing start position relatively to the drawn desired pattern such that extent of a deviation of the drawing start position between adjacent tracks of the plurality of tracks is beyond the predetermined deviation threshold value (i.e. such that the joint portion is not seen by the joint portion being connected continuously such as a straight line or a curve), if it is judged that the specified joint portion is not included in the specified not-drawn portion beyond the predetermined amount threshold value (including a case where there is no not-drawn portion in this case).

According to this aspect, if it is judged that the specified joint portion is included beyond the predetermined amount threshold value, in other words, if there is room to include the joint portion in the not-drawn portion, the displacement process is performed. On the other hand, if it is judged that the specified joint portion is not included, the joint portion cannot be included in the not-drawn portion and the effect of the displacement process is not expected, so that the displacement process is performed, which makes the joint portion not noticeable to a greater or lesser degree. As described above, the displacement process and the dispersion process can be properly used from the viewpoint of the improvement in the drawing quality, so that it is extremely useful in practice.

In another aspect of the embodiment of the drawing apparatus of the present invention, it is further provided with a third judging device (e.g. a system controller and a memory) for judging whether or not a distance along the track from the specified joint portion to the specified not-drawn portion (which is specifically an arc length along the track connecting both edges of the both portions and which may be calculated on the basis of the drawing data or which may be indirectly concerned, if it is not calculated, using the number of bits between the both portions of the drawing data for drawing the track) is below a predetermined distance threshold value (a threshold value predetermined by experiments, experiences, and simulations, as an upper limit value of the distance in which a wait time newly generated as a result of the displacement process is allowed from the viewpoint of a drawing speed), the controlling device controlling the drawing device to perform the displacement process if it is judged that the distance is below the predetermined distance threshold value, the controlling device controlling the drawing device to perform the dispersion process instead of the displacement process if it is judged that the distance is not below the predetermined distance threshold value.

According to this aspect, if it is judged that the distance is below the predetermined distance threshold value, in other words, if the joint portion and the not-drawn portion are so close that the wait time newly generated as a result of the displacement process is allowed from the viewpoint of the drawing speed, the displacement process is performed. On the other hand, if the wait time is not allowed, the dispersion process is performed near the original position in the joint portion, which makes the joint portion not noticeable to a greater or lesser degree. As described above, the displacement process and the dispersion process can be properly used from the viewpoint of the drawing speed, and the drawing quality can be also improved, so that it is extremely useful in practice.

In another aspect of the embodiment of the drawing apparatus of the present invention, it is further provided with: a rotational error specifying device (e.g. an encoder and an encoder controller) for specifying a rotational error as an error in rotation control by a spindle controller which rotates an optical disc in drawing the desired pattern, on the basis of extent of a fluctuation in a rotation period of the rotated optical disc (specifically, quantitatively specifying the rotational error from the extent of the fluctuation since the extent of the fluctuation and the rotational error have a positive correlation); and a calculation error specifying device (e.g. a system controller and a memory) for specifying a calculation error as an error of one drawing mark length (which can be referred to as “one recording mark length”, considering that the drawing action is also an action of applying the laser beam as in the data recording, wherein the laser beam is applied such that the length of a mark corresponding to one bit is this one drawing mark length) which is a length corresponding to one bit of the drawing data in the track calculated in advance, on the basis of the calculated one drawing mark length and a length of one cycle of the track (specifically, quantitatively specifying the calculation error from the magnitude of remainder with which the length of one cycle of the track is divided by one drawing mark length), the controlling device controlling the drawing device to perform the displacement process or the dispersion process if at least one of the specified rotational error and calculation error is beyond a predetermined allowable error threshold value (i.e. a threshold value predetermined by experiments, experiences, and simulations, as an upper limit value of the magnitude of the error that is not visually recognized from an organizer, or an upper limit value of the magnitude of the error that error correction is not expected any more in terms of rotation control accuracy).

According to this aspect, the displacement process or the dispersion process is selectively performed if the rotational error or calculation error is relatively large, and thus, in particular, the gap or overlap in the joint portion of each track can be visually recognized by an observer. On the other hand, if the specified rotational error or calculation error is so small that it is not visually recognized by an observer, or error correction is not expected any more in terms of rotation control accuracy, the displacement process and the like are not performed, so that a load is reduced.

### Embodiment of Drawing Method

An embodiment of the drawing method of the present invention is a drawing method in a drawing apparatus provided with: a drawing device for drawing a desired pattern onto a label surface by applying a laser beam to the label surface provided for a recording medium in accordance with drawing data on a plurality of tracks which constitute the desired pattern, the drawing method provided with: a joint specifying process of specifying a joint portion between a drawing start position at which the drawing device starts the drawing and a drawing end position at which the drawing device ends the drawing, in each of the plurality of tracks, on the basis of the drawing data; a not-drawn portion specifying process of specifying a not-drawn portion corresponding to the drawing data indicating that the laser beam is not applied, on the label surface, on the basis of the drawing data and a controlling process of controlling the drawing device to perform a displacement process of displacing the drawing start position in each of the plurality of tracks relatively to the drawn desired pattern such that the specified joint portion is included at least partially in the specified not-drawn portion.

The embodiment of the drawing method of the present invention can receive the same various effects as those that can be received by the aforementioned embodiment of the drawing apparatus of the present invention.

Incidentally, in response to the aforementioned various aspects in the embodiment of the drawing apparatus of the present invention, the embodiment of the drawing method of the present invention can also adopt various aspects.

### Embodiment of Computer Program

An embodiment of the computer program of the present invention is a computer program for controlling a computer provided in a drawing apparatus provided with: a drawing device for drawing a desired pattern onto a label surface by applying a laser beam to the label surface provided for a recording medium in accordance with drawing data on a plurality of tracks which constitute the desired pattern; a joint specifying device for specifying a joint portion between a drawing start position at which the drawing device starts the drawing and a drawing end position at which the drawing device ends the drawing, in each of the plurality of tracks, on the basis of the drawing data a not-drawn portion specifying device for specifying a not-drawn portion corresponding to the drawing data indicating that the laser beam is not applied, on the label surface, on the basis of the drawing data; and a controlling device for controlling the drawing device to perform a displacement process of displacing the drawing start position in each of the plurality of tracks relatively to the drawn desired pattern such that the specified joint portion is included at least partially in the specified not-drawn portion, the computer program making the computer function as at least the controlling device.

According to the embodiment of the computer program of the present invention, the aforementioned embodiment of the drawing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the aforementioned various aspects in the embodiment of the drawing apparatus of the present invention, the embodiment of the computer program of the present invention can also adopt various aspects.

An embodiment of the computer program product of the present invention makes the computer function as at least the controlling device.

According to the embodiment of the computer program product of the present invention, the aforementioned embodiment of the drawing apparatus of the present invention can be embodied relatively readily, by loading the computer program product from a recording medium for storing the computer program product, such as a ROM, a CD-ROM, a DVD-ROM, a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the drawing apparatus of the present invention.

Incidentally, in response to the aforementioned various aspects in the embodiment of the drawing apparatus of the present invention, the embodiment of the computer program product of the present invention can also adopt various aspects.

These operation and other advantages of the present invention will become more apparent from the example explained below.

As explained above, according to the embodiment of the drawing apparatus of the present invention, it is provided with the drawing device, the joint specifying device, the not-drawn portion specifying device, and the controlling device. According to the embodiment of the drawing method of the present invention, it is provided with the joint specifying process, the not-drawn portion specifying process, and the controlling process. According to the embodiment of the computer program of the present invention, it makes a computer function as at least the controlling device. Therefore, in drawing the desired pattern onto the label surface, it is possible to reduce the drawing time while ensuring the drawing quality.

### EXAMPLE

Hereinafter, an example of the present invention will be explained with reference to the drawings. Incidentally, the following example is explained by using the construction that the drawing apparatus or the like of the present invention is applied to an information recording/reproducing apparatus for an optical disc.

### (1) First Example

### (1-1) Basic Structure

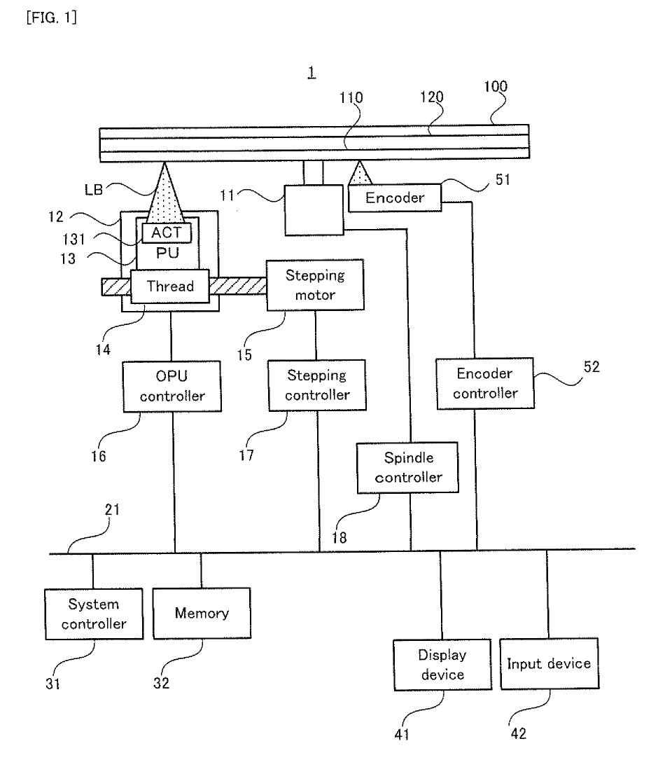

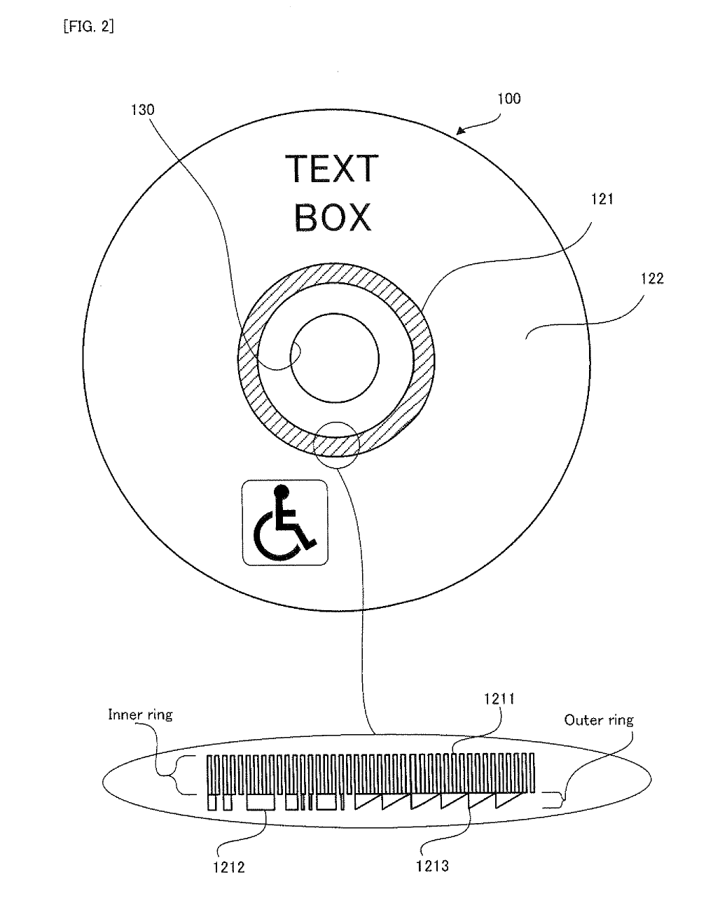

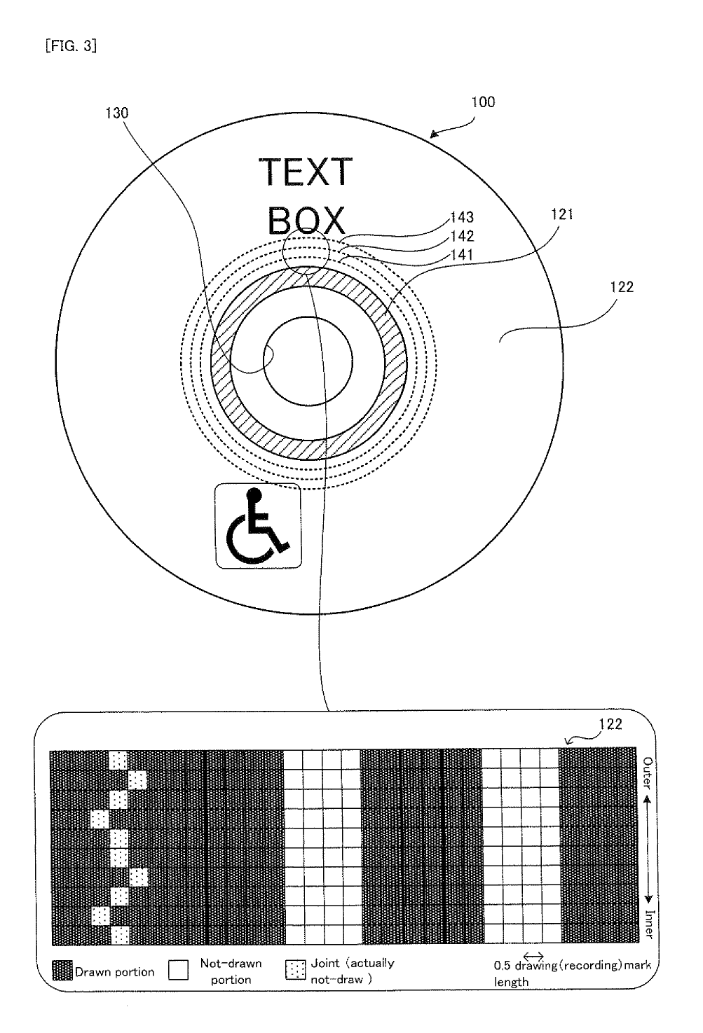

Firstly, with reference to FIG. 1 to FIG. 3, an explanation will be given on the basic structures of an information recording/reproducing apparatus in a first example and an optical disc which is a target for the operations by the information recording/reproducing apparatus. FIG. 1 is a block diagram conceptually showing the basic structure of the recording/reproducing apparatus in the first example. FIG. 2 is a plan view showing the basic structure of the optical disc (in particular, a characteristic data recording area 121) which is a target for the operations of the recording/reproducing apparatus in the first example. FIG. 3 is a plan view showing the basic structure of the optical disc (in particular, a label area 122) which is a target for the operations of the recording/reproducing apparatus in the first example.

As shown in FIG. 1, an information recording/reproducing apparatus 1 in the example is provided with a spindle motor 11, an optical pickup (OPU) unit 12, an optical pickup 13, a thread 14, a stepping motor 15, an encoder 51, a display device 41, an input device 42, an OPU controller 16, a stepping controller 17, a spindle controller 18, a system controller 31, and a memory 32.

The spindle motor 11 is a motor for rotating and stopping an optical disc 100. More specifically, the spindle motor 11 is adapted to rotate the optical disc 100 at a predetermined speed and stop it, under spindle servo under the control of the spindle controller 18.

The optical pickup unit 12 is a case for holding the optical pickup 13 and the thread 14.

The thread 14 is subjected to a driving force by the stepping motor 15 and is displaced in a radial direction of the optical disc 100 with the optical pickup unit 12.

The optical pickup 13 constitutes one specific example of the “drawing device” of the present invention. The optical pickup 13 is provided with, for example, a semiconductor laser device, a collimator lens, a light receiving element, an objective lens, which are not illustrated, and an actuator 131 or the like capable of oscillating a lens holder for the objective lens with respect to a plurality of axes, in order to perform data recording and reproduction on the optical disc 100. In the optical pickup 13, the position in the radial direction of the optical disc 100 is adjusted by the displacement of the thread 14 by the stepping motor 15, and the position is further finely adjusted by the actuator 131 disposed in the optical pickup unit 12. In other words, the position of the optical pickup 13 is determined by the displacement of the thread 14 by the stepping motor 15, and then, the irradiation position of a laser beam LB is determined by the actuator 131 which can move with higher resolution. At this time, in order to improve the displacement accuracy of the thread 14, the displacement may be performed using only a two-phase displacement position which has a high magnetic force. Moreover, the optical pickup 13 applies the laser beam LB to the optical disc 100 as reading light with a first power in the reproduction, and as writing light with a second power with it modulated in the recording. In addition, the optical pickup 13 applies the laser beam LB to the optical disc 100 in performing label drawing for the optical disc 100.

The stepping motor 15 displaces the thread 14 in the radial direction of the optical disc 100, in accordance with a voltage applied by the stepping controller 17.

The encoder 51 applies a laser beam to a characteristic data recording area 121 (refer to FIG. 2) of the optical disc 100 under the control of an encoder controller 52, and it receives the reflected light by a light receiving element, thereby obtaining velocity information and angle information about the optical disc 100. The encoder 51 and the encoder controller 52 constitute one specific example of the “rotational error specifying device” of the present invention.

The display device 41 has, for example, a liquid crystal display or a plasma display or the like, and it functions as a user interface in performing the label drawing.

The input device 42 is a tablet-type display unified with, for example, a keyboard, a mouse, or the display device 41. The input device 42 receives various inputs such as information for forming a desired pattern (e.g. a character or letter, a command, coordinate information), from a user. The received input is transmitted to the system controller 31 through the data bus 21. In accordance with the content, the desired pattern displayed on the display device 41 is changed, or a predetermined operation process is performed by the information recording/reproducing apparatus 1.

The OPU controller 16 is provided with, for example, a laser diode driver or the like, and it controls an operation of applying the laser beam LB by the optical pickup 13. Specifically, the OPU controller 16 controls the power, irradiation timing, irradiation position and the like of the laser beam LB (in other words, the operations of the optical pickup 13) in cooperation with the stepping controller 17, the spindle controller 18, and the encoder controller 52, under the control of the system controller 31.

The stepping controller 17 controls the voltage to be applied to the stepping motor 15, thereby controlling the displacement or travel distance of the thread 14 by the stepping motor 15. Specifically, the stepping controller 17 controls the displacement of the thread 14 (in other words, the operations of the stepping motor 15) in cooperation with the OPU controller 16 and the spindle controller 18, under the control of the system controller 31.

The spindle controller 18 controls the rotation of the optical disc 100 by the spindle motor 11. Specifically, the spindle controller 18 controls the rotational speed, rotational angle, or the like of the optical disc 100 (in other words, the operations of the spindle motor 11) in cooperation with the OPU controller 16 and the stepping controller 17, under the control of the system controller 31.

The spindle controller 18 controls the rotation of the optical disc 100 by the spindle motor 11. Specifically, the spindle controller 18 controls the rotational speed, rotational angle, or the like of the optical disc 100 (in other words, the operations of the spindle motor 11) in cooperation with the OPU controller 16 and the stepping controller 17, under the control of the system controller 31.

The system controller 31 constitutes one specific example of the “joint specifying device”, the “not-drawn portion specifying device”, the “controlling device”, the first judging device”, the “second judging device”, the “third judging device”, and the “calculation error specifying device” of the present invention. The system controller 31 is connected to the display device 41, the input device 42, the OPU controller 16, the stepping controller 17, the spindle controller 18, and the memory 32 through the data bus 21. The system controller 31 outputs a control command to each of the OPU controller 16, the stepping controller 17, and the spindle controller 18, thereby controlling the entire information recording/reproducing apparatus 1. Moreover, the system controller 31 allows the display device 41 to display a motion picture (in particular, the desired pattern) based on the input information from the input device 42 and the memory 32 to store the input information therein. Normally, software or firmware for the system controller 31 operating is stored in the memory 32.

The memory 32 is provided with a ROM area which stores therein a program for the information recording/reproducing apparatus 1 operating (i.e. firmware); a RAM area which temporarily stores therein data used during the operations by the information recording/reproducing apparatus 1; and the like.

Incidentally, the optical disc 100, which is the target for the operations of the recording/reproducing apparatus in the example, has a circular shape as in a DVD, for example, as shown in FIG. 1 to FIG. 3, and the optical disc 100 has a recording layer 110 laminated on one side and a label layer 120 laminated on the other side. The data recording layer 110 is irradiated with the laser beam LB from the lower side in FIG. 1, by which the data is recorded and reproduced. On the other hand, the label layer 120 is irradiated with the laser beam LB from the upper side in FIG. 1 (actually, from the lower side in FIG. 1 with the optical disc 100 turned over, by which the label is drawn.

The data recording layer 110 of the optical disc 100 is provided with, for example, a pigmented film or a phase change film whose properties (e.g. reflective properties) are changed by the irradiation of the laser beam LB. The data recording layer 110 is provided with a lead-in area, a user data area, and a lead-out area, centered on a center hole 130 (refer to FIG. 2). The data recording layer 110 also has a track such as a groove track and a land track, alternately placed spirally or concentrically, centered on the center hole 130. Moreover, on the track, the data is divided and recorded by a unit of ECC block. The ECC block is a data management unit by which the data can be error-corrected.

On the other hand, the label layer 120 of the optical disc 100 is provided with, for example, a pigmented film whose properties (e.g. reflective properties) are changed by the irradiation of the laser beam LB. The label layer 120 is not provided with the aforementioned track; however, obviously, it may be also provided with the track. The label layer 120 is provided particularly with a characteristic data recording area 121 on the innermost side and a label area 122 in which the label (i.e. one specific example of the “desired pattern” of the present invention) is actually drawn on the outer side of the characteristic data recording area 121.

The characteristic data recording area 121, as shown in the enlarged view thereof shown on the lower side in FIG. 2, has a pattern 1211 formed, in which a rectangular pattern that has a high optical reflectance and a rectangular pattern that has the same size as the rectangular pattern with a high optical reflectance and that has a low optical reflectance are regularly arranged. The pattern 1211 is read by the encoder 51. The pattern 1211 enables the information recording/reproducing apparatus 1 to obtain information about the velocity of the optical disc 100 (specifically, angular velocity or rotational speed), in performing the label drawing into the label area 122. By this, the information recording/reproducing apparatus 1 can adjust or recognize the velocity of the optical disc 100 in performing the label drawing into the label area 122.

The characteristic data recording area 121, as shown in the enlarged view thereof shown on the lower side in FIG. 2, also has a pattern 1212 formed, in which a rectangular pattern that has a high optical reflectance and a rectangular pattern that has a low optical reflectance are irregularly arranged. In particular, each of the rectangular pattern with a high optical reflectance and the rectangular pattern with a low optical reflectance has various sizes depending on a position at which each of the rectangular patterns is formed. The pattern 1212 enables the information recording/reproducing apparatus 1 to obtain information about the angle direction of the rotating optical disc 100 (i.e. a direction in which such a line is directed that extends from the center of the optical disc 100 toward a predetermined point in the surrounding of the disc). By this, the information recording/reproducing apparatus 1 can adjust or recognize the angle of the optical disc 100 in performing the label drawing into the label area 122.

The characteristic data recording area 121, as shown in the enlarged view thereof shown on the lower side in FIG. 2, also has a pattern 1213 formed, in which a saw-teeth pattern that has a high optical reflectance and a rectangular pattern that is disposed oppositely to the saw-teeth pattern with a high optical reflectance and that has a low optical reflectance are regularly arranged. The pattern 1213 enables the information recording/reproducing apparatus 1 to adjust the position of the optical pickup 13 in the radial direction of the optical disc 100, highly accurately. In other words, it is possible to adjust the tracking accuracy of the optical pickup 13 by the actuator 131.

More specifically, a duty ratio of the reflective light of the laser beam LB applied to the pattern 1213 allows the adjustment of the tracking accuracy of the optical pickup unit 12. When a predetermined voltage is applied to the actuator 131, the displacement of the optical pickup 13 from a position at which the duty ratio is 50% (i.e. the central position in the radial direction of the pattern 1213) is detected on the basis of the duty ratio. This operation is repeated while the voltage applied to the actuator 131 is changed. By this, it is possible to obtain a correlation between the voltage applied to the actuator 131 and the displacement of the optical pickup 13. After that, the obtained correlation is used to adjust the position of the optical pickup 13 in performing the label drawing into the label area 122.

Incidentally, the pattern 1211 formed on the relatively inner side is referred to as an inner ring. The inner ring is formed in an area with radius positions of 19.00 mm to 21.15 mm on the optical disc 100. On the other hand, the patterns 1212 and 1213 formed on the relatively outer side are referred to as an outer ring. The outer ring is formed in an area with radius positions of 21.15 mm to 21.80 mm on the optical disc 100. Each pattern formed in the characteristic data recording area 121 may be read by the information recording/reproducing apparatus 1 while the label is drawn into the label area 122, or each pattern may be read before the label is drawn into the label area 122. Each pattern may be also formed by a silk screen printing method or another method.

In the label area 122, as shown on the upper side in FIG. 2, a user's desired label (e.g. a character or letter, graphic, image, or the like) can be drawn. The desired label is drawn as a so-called black-and-white pattern, using a difference between the optical reflectance in the small area that is irradiated with the laser beam LB and the optical reflectance in the small area that is not irradiated with the laser beam LB.

As shown on the upper side in FIG. 3, the label drawn in the label area 122 is formed by a plurality of tracks (tracks 141, 142, 143, and so on). In other words, for example, by drawing the plurality of ring-shaped tracks in order of the tracks 141, 142, 143, and so on from the inner side, the entire label is eventually drawn. Each track is drawn roughly as follows. If the length of 1 track is 30 μm, a lens position is set for an inner circumferential position of 150 μm, and it is displaced by the actuator 131 by 30 μm from there. After the displacement by 300 μm, when the lens is displaced to an outer circumferential position of 150 μm, the thread is displaced by 300 μm, and the lens position is set again for the inner circumferential position of 150 μm, and the drawing is performed again.

In the enlarged view of the label area 122 shown on the lower side in FIG. 3, the horizontal direction of the drawing indicates the radial direction (the outer or inner circumferential direction) of the optical disc 100, and one box (or square) corresponds to a 0.5 drawing (recording) mark length. According to the enlarged view, the label drawn in the label area 122 is formed of a drawn portion, a not-drawn portion, and a joint portion. The drawn portion is formed, for example, by applying the laser beam LB with a predetermined power in accordance with drawing data of “1 (value indicating the irradiation of the laser beam LB)”. The not-drawn portion is formed, for example, by not applying the laser beam LB with a predetermined power in accordance with drawing data of “0 (value indicating the non-irradiation of the laser beam LB)”. The joint portion is a portion in which a slight gap and overlap can occur due to an error that cannot be controlled by the rotation control or the like of the spindle controller 18 which rotates the optical disc 100 or due to a calculation error. If there is such a joint portion (gap or overlap), as described in Subject to be Solved by the Invention, the drawing quality in the joint portion looks inferior to another portion.

However, the information recording/reproducing apparatus 1 in the example is provided with the optical pickup 13 which is one example of the “drawing device” of the present invention; and the system controller 31 or the like which is one example of the “joint specifying device”, the “not-drawn portion specifying device”, and the “controlling device”. Therefore, in drawing the desired pattern onto the label surface, it is possible to reduce a drawing time while ensuring the drawing quality.

### (1-2) Operation Principle

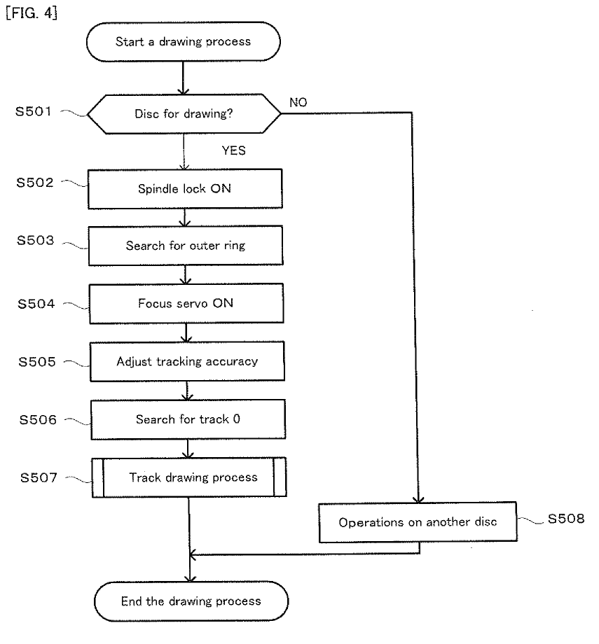

Next, with reference to FIG. 4 to FIG. 8, an explanation will be given on the operations (in particular, the drawing operation into the label layer 120) by the information recording/reproducing apparatus 1 in the example. Firstly, with reference to FIG. 4 in addition to FIG. 1 to FIG. 3, an explanation will be given on a specific operation process of the label drawing. FIG. 4 is a flowchart conceptually showing a flow of the drawing process in the first example.

In FIG. 4, firstly, it is judged whether or not the optical disc loaded on the information recording/reproducing apparatus 1 is the optical disc 100 on which the label drawing can be performed by the information recording/reproducingapparatus 1 (i.e. the aforementioned optical disc 100 in the example), under the control of the system controller 31 (step S501).

As a result of the judgment in the step S501, if it is judged that the optical disc loaded on the information recording/reproducing apparatus 1 is not the optical disc 100 on which the label drawing can be performed by the information recording/reproducing apparatus 1 (the step S501: No), operations in a step S502 to a step S507 which will be explained below are not performed, and an operation according to the loaded optical disc is performed (step S508).

On the other hand, as a result of the judgment in the step S501, if it is judged that the optical disc loaded on the information recording/reproducing apparatus 1 is the optical disc 100 on which the label drawing can be performed by the information recording/reproducing apparatus 1 (the step S501: Yes), then the spindle motor 11 is locked under the control of the spindle controller 18 (step S502). Specifically, the inner ring including the aforementioned pattern 1211 is read, and the rotational speed of the spindle motor 11 (in other words, the rotational speed of the optical disc 100) is adjusted in accordance with the reading result. After that, the rotational speed of the spindle motor 11 is kept constant.

Then, after the outer ring including the aforementioned patterns 1212 and 1213 is searched for (step S503), focus servo is turned ON (step S504).

Then, the outer ring searched for in the step S503 is used to adjust a tracking accuracy (step S505).

Then, a track 0 which is a position to start the drawing of the desired label into the label area 122 is searched for (step S506). The label layer 120 does not have a physical track, so the track 0 is virtual; however, for example, it exists in a position with a radial position of 23.80±0.03 mm on the optical disc 100.

Then, the desired label is drawn into the label area 122 by a track drawing process detailed later (step S507).

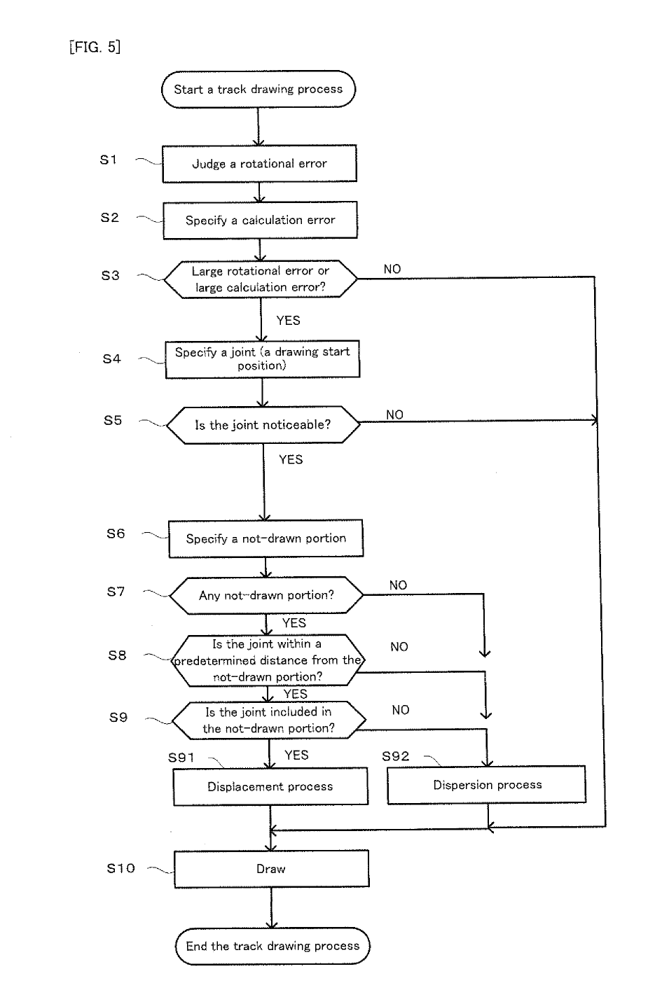

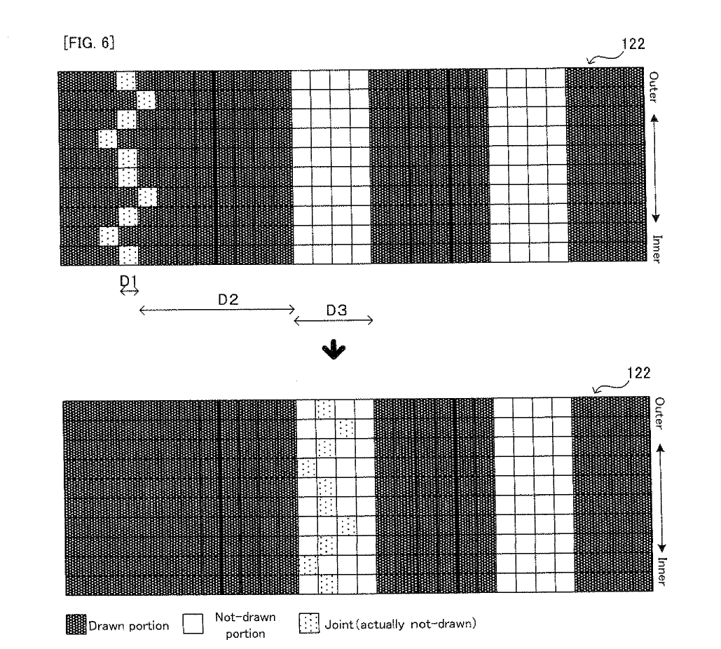

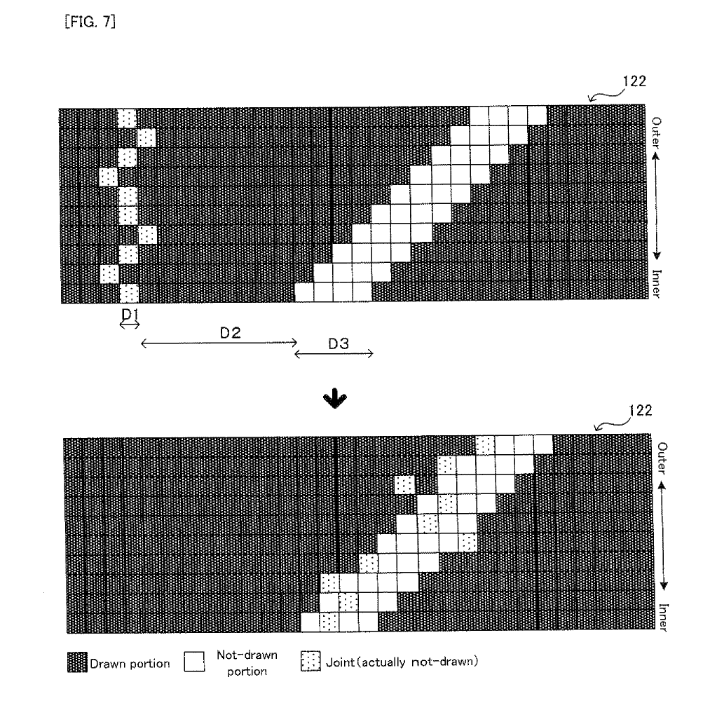

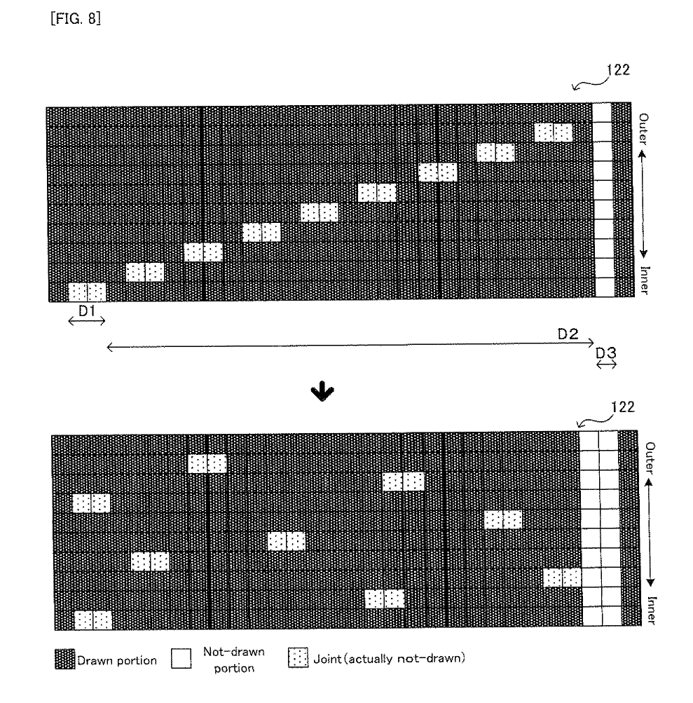

Now, the aforementioned track drawing process will be explained with reference to FIG. 6 to FIG. 8 as occasion demands, in line with FIG. 5. FIG. 5 is a flowchart conceptually showing a flow of the track drawing process. FIG. 6 is an enlarged view of the label area 122 schematically showing a result of a displacement process. FIG. 7 is an enlarged view of the label area 122 schematically showing a result of the displacement process. FIG. 8 is an enlarged view of the label area 122 schematically showing a result of a dispersion process. Incidentally, the upper side in each drawing of FIG. 6 to FIG. 8 indicates a status before the displacement process or dispersion process, and the lower side indicates a status after the process.

In FIG. 5, firstly, a rotational error of the optical disc 100 is specified by the encoder 51 and the encoder controller 52 (step S1). For example, the extent of a fluctuation in the rotation period of the optical disc 100 is specified by the encoder 51 and the encoder controller 52, and the rotational error of the optical disc 100 is specified therewith.

Simultaneously with or in tandem with this, a calculation error is specified by the system controller 31 and the memory 32 (step S2). For example, the calculation error is quantitatively specified from the magnitude of remainder with which the length of one cycle of the track 141 is divided by one drawing mark length (one recording mark length) calculated in advance.

It is judged by the system controller 31 whether or not at least one of the rotational error and the calculation error specified in this manner is beyond a predetermined allowable error threshold value (step S3). If any error is not beyond the predetermined allowable error threshold value (the step S3: NO), the specified rotational error or calculation error is so small that it cannot be visually recognized by an observer, or error correction is not expected any more in terms of rotation control accuracy. Thus, an error measure is not particularly performed, and the label is drawn as usual in each track (step S10).

On the other hand, if at least one of the errors is beyond the predetermined allowable error threshold value (the step S3: YES), the rotational error or calculation error is relatively large. Thus, in particular, the gap or overlap in the joint portion of each track is visually recognized, and this leads to a reduction in the drawing quality, so some error measurement is required. Thus, firstly, the position, placement, shape, and the like in the label area 122 of the joint portion of each track in the label area 122 (e.g. refer to FIG. 6) are specified by the system controller 31 and the memory 32 (step S4). For example, the joint portion is specified on the basis of the arrangement of bits included in one cycle of each track, a bit length corresponding to one cycle, and a deviation of a drawing start position caused by a search between the tracks.

Then, it is judged by the system controller 31 and the memory 32 whether or not the extent of the deviation of the drawing start position caused by a search in the adjacent tracks (e.g. the tracks 141 and 142) of the plurality of tracks (namely, which can be said a positional deviation in the joint portion) is below a predetermined deviation threshold value but beyond a predetermined ratio threshold value: whether or not the deviation of the drawing start position between the tracks is so small on the whole that the joint portion is noticeably disposed as viewed from an observer (step S5). If the deviation of the drawing start position between the tracks is large on the whole (the step S5: NO), this means that the joint portion is moderately dispersed such that the joint portion is not noticeable for the observer. Thus, an error measure is not particularly performed, and the label is drawn as usual in each track (the step S10).

On the other hand, if the deviation of the drawing start position between the tracks is small on the whole (the step S5: YES), the joint portion is noticeable for the observer and this can cause the reduction in the drawing quality. Thus, in accordance with the judgment described below, the displacement process or dispersion process is performed.

Before the judgment, the position, placement, shape, and the like in the label area 122 of the not-drawn portion (e.g. refer to FIG. 6) in the label area 122 are specified by the system controller 31 and the memory 32 (step S6).

At this time, it is judged whether or not there is the not-drawn portion; in other words, it is judged whether or not the not-drawn portion is specified (step S7). If there is the not-drawn portion (the step S7: YES), then, it is judged whether or not the joint portion is within a predetermined distance from the not-drawn portion (step S8). For example, it is judged whether or not a distance D2 between the joint portion and the not-drawn portion (refer to FIG. 6 to FIG. 8) is smaller than a distance corresponding to 40 percent of the length of one cycle of the track. Here, if the joint portion is within the predetermined distance from the not-drawn portion (the step S8: YES), a wait time newly generated as a result of the displacement process described later is allowed from the viewpoint of a drawing speed. Moreover, it is judged by the system controller 31 and the memory 32 whether or not the joint portion has a magnitude (width) to be included in the not-drawn portion (step S9). For example, in a certain track, it is judged whether or not a width D1 of the joint portion is less than or equal to a width D3 of the drawn portion existing in the track (refer to FIG. 6 to FIG. 8). If the joint portion has the magnitude (width) to be included in the not-drawn portion (the step S9: YES), the displacement process in the example is performed by the system controller 31 and the memory 32, as shown on the lower side in FIG. 6 and FIG. 7 (step S91). Specifically, the drawing start position in each of the plurality of tracks is displaced relatively to the desired pattern to be drawn such that the joint portion is included at least partially in the not-drawn portion. For example, as shown on the lower side in FIG. 6, the joint portion is included entirely in the not-drawn portion. At this time, the observer recognizes the gap in the joint portion as merely the not-drawn portion, and the gap is not visually recognized. In other words, as compared to a case where the displacement is not performed, the drawing quality in the joint portion is improved more. Alternatively, as shown on the lower side in FIG. 7, the joint portion is included in the not-drawn portion to some degree (e.g. over 90 percent of the total). Even at this time, the observer recognizes the gap in the joint portion as almost the not-drawn portion, and the gap is not visually recognized. Even in this case, as compared to the case where the displacement is not performed, the drawing quality in the joint portion is improved more.

On the other hand, if it is judged that there is not the not-drawn portion (the step S7: NO), or if it is judged that the joint portion is not within the predetermined distance from the not-drawn portion (the step S8: NO), or if it is judged that the joint portion does not have the magnitude (width) to be included in the not-drawn portion (the step S9: NO), the implementation of the displacement process is not preferable from the aforementioned viewpoint, so instead of the displacement process, the dispersion process is performed by the system controller 31 and the memory 32 (step S92). For example, as shown in FIG. 8, if the width D1 of the joint portion is greater than the width D3 of the not-drawn portion existing in the track, or if the distance D2 between the joint portion and the not-drawn portion is beyond the distance corresponding to 40 percent of the length of one cycle of the track, the dispersion process is performed, instead of the displacement process. As a result, if the joint portion is aligned, the joint portion is not noticeable, and the drawing quality is improved to a greater or lesser degree.

The displacement process or dispersion process is performed in this manner, and the drawing start position in each of the plurality of tracks is adjusted to a position at which the reduction in the drawing quality is not caused as much as possible, and then, the label is drawn (the step S1.0).

As is seen above, according to the information recording/reproducing apparatus 1 in the example, the displacement process, or instead of it, the dispersion process is selectively performed, so that the drawing quality in the joint portion is improved as compared to the case where those processes are not performed, and it is extremely useful in practice.

Incidentally, the order of the steps for judging in FIG. 5 may be changed as occasion demands, and the steps for judging can be also omitted, depending on circumstances, in terms of a reduction in a load process.

Moreover, the aforementioned example is explained with a light scribe technology in mind; however, it is obviously possible to receive the aforementioned effects by adopting the aforementioned construction in various applications such as other technologies for drawing the label (e.g. label flash, DiscT@2).

The present invention is not limited to the aforementioned example, but various changes may be made, if desired, without departing from the essence or spirit of the invention which can be read from the claims and the entire specification. A drawing apparatus and method, and a computer program, all of which involve such changes, are also intended to be within the technical scope of the present invention.

### INDUSTRIAL APPLICABILITY

The drawing apparatus and method and the computer program of the present invention can be applied to an information recording apparatus such as a DVD recorder, which can draw a pattern such as a character or a letter, a graphic, and an image, onto a label surface of a recording medium such as a DVD. Moreover, they can be also applied to an information recording apparatus or the like which is mounted on or connected to various computer equipment for consumer use or for commercial use.

1. A drawing apparatus comprising:
a drawing device for drawing a desired pattern onto a label surface by applying a laser beam to the label surface provided for a recording medium in accordance with drawing data on a plurality of tracks which constitute the desired pattern;
a joint specifying device for specifying a joint portion between a drawing start position at which said drawing device starts the drawing and a drawing end position at which said drawing device ends the drawing, in each of the plurality of tracks, on the basis of the drawing data; a not-drawn portion specifying device for specifying a not-drawn portion corresponding to the drawing data indicating that the laser beam is not applied, on the label surface, on the basis of the drawing data; and a controlling device for controlling said drawing device to perform a displacement process of displacing the drawing start position in each of the plurality of tracks relatively to the drawn desired pattern such that the specified joint portion is included at least partially in the specified not-drawn portion.

2. The drawing apparatus according to claim 1, further comprising a first judging device for judging whether or not extent of a deviation of the drawing start position between adjacent tracks of the plurality of tracks is below a predetermined deviation threshold value but beyond a predetermined ratio threshold value, said controlling device controlling said drawing device to perform the displacement process if it is judged that the extent is beyond the predetermined ratio threshold value.

3. The drawing apparatus according to claim 2, further comprising a second judging device for judging whether or not the joint portion specified on the label surface is included in the specified not-drawn portion beyond predetermined amount threshold value, said controlling device controlling said drawing device to perform the displacement process if it is judged that the specified joint portion is included in the specified not-drawn portion beyond the predetermined amount threshold value, said controlling device controlling said drawing device to perform, instead of the displacement process, a dispersion process of displacing the drawing start position relatively to the drawn desired pattern such that extent of a deviation of the drawing start position between adjacent tracks of the plurality of tracks is beyond the predetermined deviation threshold value, if it is judged that the specified joint portion is not included in the specified not-drawn portion beyond the predetermined amount threshold value.

4. The drawing apparatus according to claim 3, further comprising a third judging device for judging whether or not a distance along the track from the specified joint portion to the specified not-drawn portion is below a predetermined distance threshold value, said controlling device controlling said drawing device to perform the displacement process if it is judged that the distance is below the predetermined distance threshold value, said controlling device controlling said drawing device to perform the dispersion process instead of the displacement process if it is judged that the distance is not below the predetermined distance threshold value.

5. The drawing apparatus according to claim 3, further comprising:
a rotational error specifying device for specifying a rotational error as an error in rotation control by a spindle controller which rotates an optical disc in drawing the desired pattern, on the basis of extent of a fluctuation in a rotation period of the rotated optical disc; and a calculation error specifying device for specifying a calculation error as an error of one drawing mark length which is a length corresponding to one bit of the drawing data in the track calculated in advance, on the basis of the calculated one drawing mark length and a length of one cycle of the track, said controlling device controlling said drawing device to perform the displacement process or the dispersion process if at least one of the specified rotational error and calculation error is beyond a predetermined allowable error threshold value.

6. A drawing method in a drawing apparatus comprising: a drawing device for drawing a desired pattern onto a label surface by applying a laser beam to the label surface provided for a recording medium in accordance with drawing data on a plurality of tracks which constitute the desired pattern, said drawing method comprising:
a joint specifying process of specifying a joint portion between a drawing start position at which said drawing device starts the drawing and a drawing end position at which said drawing device ends the drawing, in each of the plurality of tracks, on the basis of the drawing data; a not-drawn portion specifying process of specifying a not-drawn portion corresponding to the drawing data indicating that the laser beam is not applied, on the label surface, on the basis of the drawing data; and a controlling process of controlling said drawing device to perform a displacement process of displacing the drawing start position in each of the plurality of tracks relatively to the drawn desired pattern such that the specified joint portion is included at least partially in the specified not-drawn portion.

7. A computer-readable medium containing a computer program for controlling a computer provided in a drawing apparatus comprising: a drawing device for drawing a desired pattern onto a label surface by applying a laser beam to the label surface provided for a recording medium in accordance with drawing data on a plurality of tracks which constitute the desired pattern; a joint specifying device for specifying a joint portion between a drawing start position at which said drawing device starts the drawing and a drawing end position at which said drawing device ends the drawing, in each of the plurality of tracks, on the basis of the drawing data; a not-drawn portion specifying device for specifying a not-drawn portion corresponding to the drawing data indicating that the laser beam is not applied, on the label surface, on the basis of the drawing data; and a controlling device for controlling said drawing device to perform a displacement process of displacing the drawing start position in each of the plurality of tracks relatively to the drawn desired pattern such that the specified joint portion is included at least partially in the specified not-drawn portion, said computer program making the computer function as at least said controlling device.
